(19) United States
(12) Patent Application Publication
(10) Pub. No.: US 2008/0314641 A1
(43) Pub. Date: Dec. 25, 2008

(54) Directional Drilling System and Software Method

(76) Inventor: Kevin McClard, Houston, TX (US)

Correspondence Address: KENNETH L. NASH, P.O. BOX 680106, HOUSTON, TX, 77268-0106, US

(21) Appl. No.: 11/765,593

(22) Filed: Jun. 20, 2007

(51) Int. Cl. E21B 7/00; G06F 19/00

(52) U.S. Cl. 175/57

(57) ABSTRACT

A software method for directionally drilling a plurality of wells capable of providing directional drilling services to hundreds of wells. The software method may comprise steps from determining a BHA for a portion of a well, determining a deviation between the desired trajectory of the well bore and an actual trajectory of the well bore as measured at the nonmagnetic measurement portion of the bottom hole assembly, determining a dogleg of the actual trajectory, and determining a correction trajectory to reduce the deviation between the desired trajectory and the actual trajectory which produces a dogleg less than a predetermined value. The trajectory may be projected to the bit even though the nonmagnetic measurement portion of the bottom hole assembly is often separated therefrom by significant distances.

### BACKGROUND OF THE INVENTION

1. Field of the Invention

The present invention relates generally to directional drilling and, more particularly, to directional drilling expert software, that controls surface and/or subsurface components of a drilling system to direct the direction of drilling along a proposed well path.

2. Description of the Background

Directional drilling typically involves drilling non-vertical wells. A specialized type of driller, a directional driller, is often utilized to control the drilling rig for this purpose. Typically, the directional drillers are given a well path to follow that is predetermined by engineers and geologists before the drilling commences.

Directional wells may be drilled for purposes such as: (1) increasing the exposed section length through the reservoir by drilling through the reservoir at an angle (2) drilling into the reservoir where vertical access is difficult or not possible such as within a city or under a lake (3) allowing more wellheads to be grouped together on one surface location such as on an oil platform and other reasons such as (4) drilling “relief wells” to relieve the pressure of a blow out well.

Generally a special configuration of drilling equipment (“Bottom Hole Assembly” or “BHA”) is used in directional drilling. The BHA may typically comprise components such as bits, stabilizers, drill collars, reamers, drilling jars, heavy weight pipe, and the like. Weight is applied to the bit by releasing drill string tension at the surface whereby a proportion of the weight of the BHA is applied to the bit. Downhole drilling motors are often used in the BHA for directional drilling. The bit is then rotated downhole by the hydraulic power of drilling mud circulated down the drill string while most of the drill pipe is held stationary and slides downward with drilling. A bent tubular (a “bent sub”) may be used between the stationary drill pipe and the drill bit for orienting the drill bit in a selectable direction. The “tool face” is then the direction in which the bit oriented. When possible, depending on the measurement tool available, the tool face may be measured with reference to magnetic north or the high side of the hole, e.g., the 12:00 o'clock or uppermost position in the well bore. As noted below, the tool face orientation will typically change due to drill bit torque, weight on the bit, drilling fluid flow rate, the formation, and related forces that may twist the drill string.

In some cases, the angle of bend of the bent sub may be adjustable during operation by signaling downhole, but the bent sub is nontheless effectively usually fixed during drilling. In other types of drilling, the bend may change dynamically as the drill string is rotated. For example, rotary steerable tools offer a variably moveable section whereby three dimensional control of the bit may be achieved without stopping the drill string rotation.

Measurements are made during drilling to indicate if the well is following the planned path. The measurements may include the inclination (deviation from the vertical) and azimuth (direction with respect to the geographic grid in which the wellbore is running from the vertical). When a magnetic compass is used to determine the azimuth, then the magnetic compass may be positioned within non-magnetic drill collar to reduce the magnetic effect of the metallic drill sting.

Periodic surveys may be taken with a downhole camera instrument (“single shot camera”) to provide snapshots of survey data (inclination and azimuth) of the well bore and/or for other purposes such as to orient the tool face. These pictures are typically taken at intervals between 30-500 feet, with 90 feet common during active changes of angle or direction, and distances of 200-300 feet being typical while “drilling ahead” (not making active changes to angle and direction). In other cases, a steering tool such as an MWD (measurement while drilling) tool may utilize mud pulse telemetry, EM telemetry, wireline, or the like, to send continuous directional data back to the surface without disturbing drilling operations.

When directional drilling using only the single shot camera, the orientation of the tool face may made by the directional driller while drilling is stopped. However, once drilling begins, the tool face orientation will typically change due to drill bit torque, weight on the bit, drilling fluid flow rate, the formation, and related forces that may twist the drill string.

The use of one or more non-magnetic drill collars generally means that the magnetic compass survey is not taken at the drill bit but might be, for instance, 30-300 feet or so above the drill bit, although presently 30-70 feet is typical. Thus, the directional driller cannot guarantee for sure in what direction the well is actually being drilled at any given moment. He must extrapolate from readings taken further up the borehole where the non-magnetic drill collars permit magnetic compass readings to be taken.

During critical angle and direction changes, especially while using a downhole motor, the MWD tool may be added to the drill string to provide continuously updated measurements that may be used for (near) real-time adjustments. However, even with an MWD tool, the drilling may not proceed in the direction of the tool face due to various factors which might include changing formations, bit wear, washouts, hard spots, bit vibration patterns, slip-stick (repeated sticking and slipping of the bit), and the like. Again, due to the offset between the drill bit and the magnetic sensor, the directional driller will not know for sure in what direction the bit is actually drilling. Interpolation of drilling direction from the readings made further up the hole can be inaccurate.

If the actual drilling path differs from the desired trajectory, then three dimensional corrections must then be made to attempt to get back onto or near the desired drill path. The corrections may need to stay within a desired amount of change in the borehole sometimes referred to as the dogleg, or degree change per hundred feet. Directional drillers therefore need to make changes and project where they believe the drilling will be going as a result of the changes. The directional driller will not know the result of changes made until the drilling proceeds to move the compass section to the depth at which the changes were initiated. As an example, since the MWD equipment that measures the orientation of the drill string is nearly always located 30-70 feet above the drill bit, the directional driller cannot actually know where the bit is at, but must project to where he thinks it. The job is especially problematic when beginning a kick-off, which requires drilling in the desired direction, normally from a vertical position. Although the directional driller has carefully selected the drilling device and made initial planning, it is not known how a given formation will respond to the drilling regime they have in mind. As an example, suppose it is desired to drill a curve that changes angle by 3 degrees per 100 feet and the directional driller projects the need to orient the motor for 15 feet per 30 feet to accomplish this. Once the drilling proceeds to a point where surveys can be taken to see how accurate the initial projection is, it might be that drilling is 2.5 degrees per 100 instead of 3. So he calculates a new projection of orienting the motor for 18 feet (instead of the 15 they used previously) to get 3 degrees per 100, but he must also try to catch up to add an additional 3 feet of orientation on the next section to be drilled. Decisions are tempered by various limitations. It may be the amount of curvature they can build and/or the amount of weight which can be applied to the bit is limited. In addition to monitoring the direction of the well, the directional driller will be aware that the deflection is also affected by the weight on bit and flow rate of the mud being circulated through the drill string. Also, when the directional driller is not orienting and is rotary drilling, then the speed of rotation can affect the amount of directional change. Directional drillers will normally use a survey calculation computer program and their own intuition to help them with their projections.

For reasons such as those discussed above, directional drilling is often considered an art wherein some directional drillers may be successful in a field or region but others are not. Some directional drillers utilize a ouija board to make calculations. Although the ouija board does provide a means for making certain kinds of calculations, the effect of use of a ouija board is often appropriate for the type of job that is done. Directional drillers must often stay awake for long periods of time and therefore the decisions of the directional drillers are particularly subject to human errors. While directional drillers may also take advantage of computer programs, calculators, and the like, to make their projections, each directional driller may utilize different techniques. Directional drilling services are not standardized. The above available tools do not insure results. Some directional drillers may be successful in some fields but not others. Accordingly, directional drillers are specialists who command a high daily fee.

Much more costly than directional drillers are downhole directional drilling systems that utilize varible pads, rotary steerable drives as described briefly above, compass sections very close to the drill bit, and the like, in a downhole closed-loop directional drilling system. However, these downhole closed-loop drilling systems are very expensive. They are subject to drilling errors as discussed even with the high costs thereof. Moreover, the failure of a device therein requires a relatively lengthy time for replacement because the entire drill string must be removed from the wellbore and then reinserted. Therefore, more traditional drilling assemblies are likely to be used for the majority of drilling for the foreseeable future.

The following prior art discloses patents and/or articles that attempt to solve the above and/or related problems:

US Publication 2004/0153245A, by Keith Womer et al., discloses a system and method for controlling operation of a drilling rig having a control management system that comprises programming the control system with at least one resource module. The at least one resource module has at least one operating model having at least one set of programmed operating rules related to at least one set of operating parameters. In addition, the system and method provide an authenticating hierarchical access to at least one user to the at least one resource module.

U.S. Pat. No. 6,233,524, to Harrell et al., discloses a closed-loop drilling system for drilling oilfield boreholes. The system includes a drilling assembly with a drill bit, a plurality of sensors for providing signals relating to parameters relating to the drilling assembly, borehole, and formations around the drilling assembly. Processors in the drilling system process sensors signal and compute drilling parameters based on models and programmed instructions provided to the drilling system that will yield further drilling at enhanced drilling rates and with extended drilling assembly life. The drilling system then automatically adjusts the drilling parameters for continued drilling. The system continually or periodically repeats this process during the drilling operations. The drilling system also provides severity of certain dysfunctions to the operator and a means for simulating the drilling assembly behavior prior to effecting changes in the drilling parameters.

US Publication 2006/0081399A, by Franklin B. Jones, discloses a method and control system for directional drilling are described. A drill string motor is commanded to rotate at a constant speed in a forward direction and the constant speed in a reverse direction for a first duration and a second duration, respectively, for at least one oscillation cycle. The difference between an averaged absolute angle of the drill string and a target rotation angle for the drill string is maintained near zero by adjusting the length of the durations as necessary. The target rotation angle can be changed based on measurement while drilling data obtained during drilling operations. Advantageously, friction between the drill string and bore hole is reduced, leading to an increase in the drilling penetration rate.

US Publication 2005/0269082 by Baron et al., discloses a method for determining a rate of change of longitudinal direction of a subterranean borehole is provided. The method includes positioning a downhole tool in a borehole, the tool including first and second surveying devices disposed thereon. The method further includes causing the surveying devices to measure a longitudinal direction of the borehole at first and second longitudinal positions and processing the longitudinal directions of the borehole at the first and second positions to determine the rate of change of longitudinal direction of the borehole between the first and second positions. The method may further include processing the measured rate of change of longitudinal direction of the borehole and a predetermined rate of change of longitudinal direction to control the direction of drilling of the subterranean borehole. Exemplary embodiments of this invention tend to minimize the need for communication between a drilling operator and the bottom hole assembly, thereby advantageously preserving downhole communication bandwidth.

US Publication 2005/0278123 by Alft et al., discloses systems for electronic development of a bore plan for use in connection with an underground boring machine. Electronically developing a bore plan involves providing topographical information representative of topography of the bore site and providing bore path information representative of an intended bore path for the bore site. The bore path information includes at least two target points through which the intended bore path is to pass. The intended bore path can define a pilot bore path or a backream path. The target points comprise an entry point and an exit point, and each of the target points is defined by at least a distance value, lateral value, and a depth value.

US Publication 2006/0081399 by Franklin B. Jones discloses a method and control system for directional drilling. A drill string motor is commanded to rotate at a constant speed in a forward direction and the constant speed in a reverse direction for a first duration and a second duration, respectively, for at least one oscillation cycle. The difference between an averaged absolute angle of the drill string and a target rotation angle for the drill string is maintained near zero by adjusting the length of the durations as necessary. The target rotation angle can be changed based on measurement while drilling data obtained during drilling operations. Advantageously, friction between the drill string and bore hole is reduced, leading to an increase in the drilling penetration rate.

US Publication 2006/0185900, by Jones et al., discloses a method for communicating with a downhole tool located in a subterranean borehole is disclosed. Exemplary embodiments of the method include encoding data and/or commands in a sequence of varying drill string rotation rates and drilling fluid flow rates. The varying rotation rates and flow rates are measured downhole and processed to decode the data and/or the commands. In one exemplary embodiment, commands in the form of relative changes to current steering tool offset and tool face settings are encoded and transmitted downhole. Such commands may then be executed, for example, to change the steering tool settings and thus the direction of drilling. Exemplary embodiments of this invention advantageously provide for quick and accurate communication with a downhole tool.

U.S. Pat. No. 6,101,444, to Michael Stoner, discloses a numerical control unit and method is provided for determining a change in a positional setting in a downhole tool used to drill a wellbore, the numerical control unit comprising a plurality of rules in an IF . . . THEN format based on the current position of the wellbore and a preferred position of the wellbore.

U.S. Pat. No. 6,092,610, to Kosmala et al., discloses an actively controlled rotary steerable drilling system for directional drilling of wells having a tool collar rotated by a drill string during well drilling. A bit shaft has an upper portion within the tool collar and a lower end extending from the collar and supporting a drill bit. The bit shaft is omni-directionally pivotally supported intermediate its upper and lower ends by a universal joint within the collar and is rotatably driven by the collar. To achieve controlled steering of the rotating drill bit, orientation of the bit shaft relative to the tool collar is sensed and the bit shaft is maintained geostationary and selectively axially inclined relative to the tool collar during drill string rotation by rotating it about the universal joint by an offsetting mandrel that is rotated counter to collar rotation and at the same frequency of rotation. An electric motor provides rotation to the offsetting mandrel with respect to the tool collar and is servo-controlled by signal input from position sensing elements such as magnetometers, gyroscopic sensors, and accelerometers which provide real time position signals to the motor control. In addition, when necessary, a brake is used to maintain the offsetting mandrel and the bit shaft axis geostationary. Alternatively, a turbine is connected to the offsetting mandrel to provide rotation to the offsetting mandrel with respect to the tool collar and a brake is used to servo-control the turbine by signal input from position sensors.

US 2006/0254825, to Krueger et al., discloses a drilling assembly for drilling deviated well bores. The drilling assembly includes a drill bit at the lower end of the drilling assembly. A drilling motor provides the rotary power to the drill bit. A bearing assembly of the drilling motor provides lateral and axial support to the drill shaft connected to the drill bit. A steering device is integrated into drilling motor assembly. The steering device contains a plurality of force application members disposed at an outer surface of the drilling motor assembly. Each force application member is adapted to move between a normal position and a radially extended position to exert force on the wellbore interior when in extended position. A power unit in the housing provides pressurized fluid to the force application members. A control device for independently operating each of the force application members is disposed in the drilling motor assembly. A control circuit or unit independently controls the operation of the control device to independently control each force application member. For short radius drilling, a knuckle joint is disposed uphole of the steering device to provide a bend in the drilling assembly. During drilling of a wellbore, the force application members are operated to adjust the force on the wellbore to drill the wellbore in the desired direction.

U.S. Pat. No. 6,732,052, to Macdonald et al., discloses a drilling system that utilizes a neural network for predictive control of drilling operations. A downhole processor controls the operation of the various devices in a bottom hole assembly to effect changes to drilling parameters and drilling direction to autonomously optimize the drilling effectiveness. The neural network iteratively updates a prediction model of the drilling operations and provides recommendations for drilling corrections to a drilling operator.

US 2004/0216921, to Volker Krueger, discloses a system and method of controlling a trajectory of a wellbore comprises conveying a drilling assembly in the wellbore by a rotatable tubular member. The drilling assembly includes a drill bit at an end thereof that is rotatable by a drilling motor carried by the drilling assembly. The drilling assembly has a first adjustable stabilizer and an second stabilizer spaced apart from the first adjustable stabilizer. The first adjustable stabilizer having set of ribs spaced around the stabilizer, with each rib being independently radially extendable. The position of a first center of the first adjustable stabilizer is adjusted in the wellbore relative to a second center of the second stabilizer in the wellbore for controlling the trajectory of the wellbore.

U.S. Pat. No. 6,439,325, to Peters et al., discloses apparatus for power transfer over a nonconductive gap between rotating and non-rotating members of downhole oilfield tools. The gap may contain a non-conductive fluid, such as drilling fluid or oil for operating hydraulic devices in the downhole tool. The downhole tool, in one embodiment, is a drilling assembly wherein a drive shaft is rotated by a downhole motor to rotate the drill bit attached to the bottom end of the drive shaft. A substantially non-rotating sleeve around the drive shaft includes a plurality of independently operated force application members used to exert the force required to maintain and/or alter the drilling direction. In the preferred system, one or more mechanically operated devices such as hydraulic units control the force application members. A transfer device transfers electrical power between the rotating and non-rotating members, and the electric power is converted directly to mechanical power. An electronic control circuit or unit associated with the rotating member controls the transfer of power between the rotating member and the non-rotating member.

US 2004/0020691, to Volker Krueger, discloses continuous or near continuous motion drill strings which include motion sensitive and other MWD sensors which take stationary measurements while the drilling assembly is continuing to drill the wellbore. For simultaneous continuous drilling and stationary measurements, the present invention provides a drilling assembly wherein a force application system almost-continuously applies force on the drill bit while maintaining a housing or drill collar section stationary. Motion sensitive sensors carried by the drill collar take stationary measurements. A steering device between the drill bit and the force application system maintains drilling of the wellbore along a prescribed well path.

US 2003/0146022, to Volker Krueger, discloses a drilling assembly that includes a mud motor that rotates a drill bit and a set of independently expandable ribs. A stabilizer uphole of the ribs provides stability. A second set of ribs may be disposed on the drilling assembly. Vertical and curved holes are drilled by rotating the drill bit by the mud motor and by independently adjusting the rib forces. The drill string is not rotated. Inclined straight sections and curved sections may be drilled by independent adjustment of the rib forces and by rotating the drill bit with the motor, without rotating the drill string. Inclined sections or curved sections in the vertical plane are drilled by superimposing the drill string rotation on the mud motor rotation and by setting the rib forces to the same predetermined values. Rib forces are adjusted if the drilling direction differs from the defined inclination. The system is self-adjusting and operates in a closed loop manner. Inclination and navigation sensor data are processed by a downhole controller. The force vectors maybe programmed in the downhole controller. Command signals from a surface controller may be sent to initiate the setting and/or adjustment of the rib forces or the rib force vector.

U.S. Pat. No. 6,626,254, to Krueger et al., discloses a drilling assembly for drilling deviated well bores. The drilling assembly includes a drill bit at the lower end of the drilling assembly. A drilling motor provides the rotary power to the drill bit. A bearing assembly of the drilling motor provides lateral and axial support to the drill shaft connected to the drill bit. A steering device is integrated into drilling motor assembly. The steering device contains a plurality of force application members disposed at an outer surface of the drilling motor assembly. Each force application member is adapted to move between a normal position and a radially extended position to exert force on the wellbore interior when in extended position. A power unit in the housing provides pressurized fluid to the force application members. A control device for independently operating each of the force application members is disposed in the drilling motor assembly. A control circuit or unit independently controls the operation of the control device to independently control each force application member. For short radius drilling, a knuckle joint is disposed uphole of the steering device to provide a bend in the drilling assembly. During drilling of a wellbore, the force application members are operated to adjust the force on the wellbore to drill the wellbore in the desired direction.

US 2005/0149306, to William King, discloses an iterative drilling simulation method and system for enhanced economic decision making includes obtaining characteristics of a rock column in a formation to be drilled, specifying characteristics of at least one drilling rig system; and iteratively simulating the drilling of a well bore in the formation. The method and system further produce an economic evaluation factor for each iteration of drilling simulation. Each iteration of drilling simulation is a function of the rock column and the characteristics of the at least one drilling rig system according to a prescribed drilling simulation model.

Baker Hughes website www.bakerhughesdirect.com/INTEQ discloses a rotary closed loop system comprising a steering unit at the drill bit.

Performance Drilling Technology website www.wivsum.com developed by the present inventor, discloses borehole surveying, well planning, and service calculation applications that may be utilized for drilling boreholes including during directional drilling procedures.

The above cited art does not provide directional drilling expert software for controlling a plurality of drilling operations simultaneously that may be utilized with surface equipment and less expensive bottom hole assemblies to reduce directional drilling costs and improve directional drilling accuracy. Those skilled in the art have long sought and will appreciate the present invention that addresses these and other problems.

### SUMMARY OF THE INVENTION

It is an object of the present invention to provide directional drilling expert software that effects a continuous control system for directionally drilling of a well in accord with their desired well trajectory.

It is yet another object of the present invention to directionally drill a plurality of wells, perhaps hundreds simultaneously, while replacing the directional driller on most if not all of the well sites. In one embodiment, human oversight may be provided at a remote location wherein the human oversight may comprise a small group of directional drillers, perhaps with one on duty at a time to oversee a large number of wells simultaneously.

These and other objects, features, and advantages of the present invention will become apparent from the drawings, the descriptions given herein, and the appended claims. However, it will be understood that the above-listed objectives and/or advantages of the invention are intended only as an aid in quickly understanding aspects of the invention, are not intended to limit the invention in any way, and therefore do not form a comprehensive or restrictive list of objectives, and/or features, and/or advantages.

Accordingly, the present invention may comprise directional drilling expert software that may be utilized to drill a plurality of wells and to eliminate the need to have directional drillers on site at each well, and whereupon a single directional driller, or small group of directional drillers, or other human overseers might monitor the directional driller expert software as it handles hundreds of wells.

The method may comprise steps such as inputting a desired trajectory of the well bore and/or other requirements of the well such as any equipment limitations, remoteness of the well site with respect to determining the need for advance time to transport equipment, and the like.

In one possible embodiment or situation, the software may be utilized determine a plurality of bottom hole assemblies (BHA) which may be used to drill the different portions of the desired trajectory. Preferably, the actual bottom hole assembly components will be manually input or checked off verify that the directional drilling expert software is apprised of what BHA is utilized and is able to make calculations/outputs based thereon.

During at least one portion of the directional drilling, the bottom hole assembly may comprise a downhole drilling motor, a bent sub, a bit, and a nonmagnetic measurement portion. In a preferred embodiment, the distance between the bit and the nonmagnetic measurement portion of the bottom hole assembly is determined based on the actual bottom hole assembly components.

Variables such as measured depth of the wellbore are input. Outputs of the directional drilling expert software may comprise a selection of a rotating mode of drilling or a sliding mode of drilling based on the desired trajectory of the well bore and the measured depth.

During the rotating mode of drilling, a measured RPM may typically comprise at least one input to the software whereupon the software verifies the measured RPM is the desired RPM and, if a different RPM is determined to be more useful, then the software outputs an adjusted RPM. Another preferred input may be a measured drill string tension at a surface position whereupon the software verifies the measured drill string tension is a desired surface drill string tension and, if not, then output an adjusted rotating mode drill string tension.

During the sliding mode of drilling when exclusively utilizing the downhole drilling motor for rotating the bit, variables may be inputted to the software on a continuing basis comprising a measured angular position of the drill string at a surface position, sliding surface drill string tension, mudflow rate, and/or azimuth and inclination taken at the nonmagnetic measurement portion. Directional driller expert software evaluates the inputs and, if necessary, then outputs an adjusted angular position, an adjusted sliding mode drill string tension, and an adjusted mud flow rate to maintain a tool face of the bit wherein a projected direction of drilling may be determined utilizing the distance between the bit and the nonmagnetic measurement portion of the bottom hole assembly and the desired trajectory.

The software method may further comprise determining a deviation between the desired trajectory of the well bore and an actual trajectory of the well bore as measured at the nonmagnetic measurement portion of the bottom hole assembly, determining a dogleg of the actual trajectory, and determining a correction trajectory to reduce the deviation between the desired trajectory and the actual trajectory which produces a dogleg less than a predetermined value.

During the sliding mode, the method may comprise outputting a command to change at least one of the adjusted angular position, the adjusted sliding mode drill string tension, and an adjusted mud flow rate to provide a corrected tool face of the bit wherein the projected direction of drilling is determined utilizing the distance between the bit and the nonmagnetic measurement portion of the bottom hole assembly. The distance between the bit and the nonmagnetic measurement portion of the bottom hole assembly may vary and the software may often have to make this calculation when the distance is greater than 60 feet.

For the sliding mode of drilling, the software may, if desired, evaluate a rate of drilling and outputting a command to change at least one of the adjusted angular position, an adjusted sliding mode drill string tension, and an adjusted mudflow rate when the rate of drilling drops below a selected rate of drilling. When utilizing a wire line retrievable magnetic compass for inputting the azimuth and the inclination, the software may predict the effect of this change noted directly above on a projected tool face and then compensate by outputting a command to change another of the angular position, the adjusted sliding mode drill string tension, and the adjusted mud flow rate to maintain the projected tool face of the bit wherein the resulting projected direction of drilling is determined, as noted above, by utilizing the distance between the bit and the nonmagnetic measurement portion of the bottom hole assembly and the new desired trajectory.

When utilizing an MWD tool for inputting the azimuth and the inclination the software may compensate for the above step by outputting a command to change another of the angular position, the adjusted sliding mode drill string tension, and the adjusted mud flow rate to maintain a selected tool face that is predicted to most closely produce the desired trajectory.

The software method may further comprise measuring a rate of drilling and selectively outputting a command to pick up the drilling string in the rotating mode or to pick up the drill string in the sliding mode when the rate of drilling drops below a selected rate of drilling for the sliding mode or for the rotating mode, then subsequently slacking off to the adjusted rotating mode drill string tension or the adjusted sliding mode drill string tension. For the rotating mode, the method may comprise measuring the rate of drilling and outputting a command to change at least one of the adjusted RPM or the adjusted rotating mode drill string tension when the rate of drilling drops below a selected rate of drilling.

The software method may further comprise inputting a friction factor for the drill string, inputting an effective OD of drill string components, determining a friction of the drill string, and utilizing the friction of the drill string for calculating a weight on bit whereby the adjusted sliding mode drill string tension is selected.

The software method may further comprise inputting a mud weight and determining a buoyancy of the drill string, and utilizing the buoyancy of the drill string for calculating a weight on bit whereby the adjusted sliding mode drill string tension is selected.

The above and/or other steps may be utilized in accord with the present invention.

### BRIEF DESCRIPTION OF THE DRAWINGS

FIG. 1 is a side elevational view with respect to true vertical depth of one possible desired well path trajectory in accord with one possible embodiment of the present invention;

FIG. 2 is a top view of the well path trajectory of FIG. 1 in feet with respect to North-South and East-West axes in accord with one possible embodiment of the present invention;

FIG. 3 is a perspective underground view of a well requiring correction to a projected well path among a plurality of wells in accord with one possible embodiment of the present invention;

FIG. 4 is a view of a hydraulics report that may be utilized and/or projected and includes measured and/or calculated hydraulic factors that may be utilized and/or projected by software in accord with one possible embodiment of the present invention;

FIG. 5 is a bottom hole assembly (BHA) corresponding to the hydraulics report of FIG. 4 that may be utilized and/or projected in accord with one possible embodiment of the present invention;

FIG. 6 is a surface rig with sensors and actuators that provide inputs and outputs for software in accord with the present invention;

FIG. 7 is a view of a drilling summary report that may be utilized and/or projected and includes measured and/or calculated hydraulic factors that may be utilized and/or projected by software in accord with one possible embodiment of the present invention; and

FIG. 8 is a schematic of a generalized flow diagram for operation of directional drilling software in accord with one possible embodiment of the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention and as defined in the appended claims.

### DETAILED DESCRIPTION OF THE PREFERRED EMBODIMENTS

The present invention effectively provides a directional driller expert software system which, when given the projected well path, will then perform the functions of a directional driller in planning the bottom hole assembly, controlling the rig motors, receiving magnetic survey information, making adjustments to the tool face, and the like, as discussed below. While in the prior art, a directional driller is necessary for each well, in accord with the present invention, a single directional driller or other human overseer may be used to oversee many, and perhaps hundreds of wells simultaneously, thereby saving considerable costs.

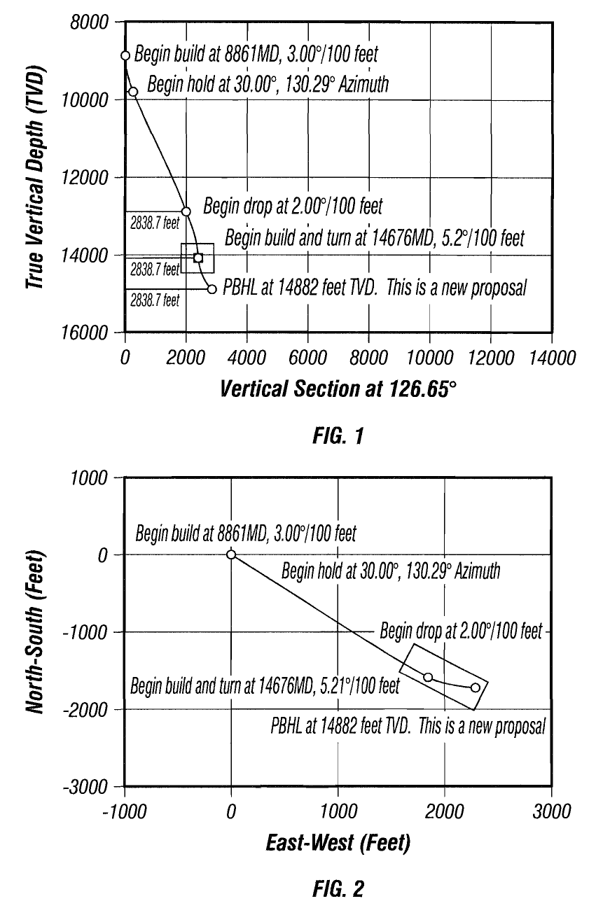

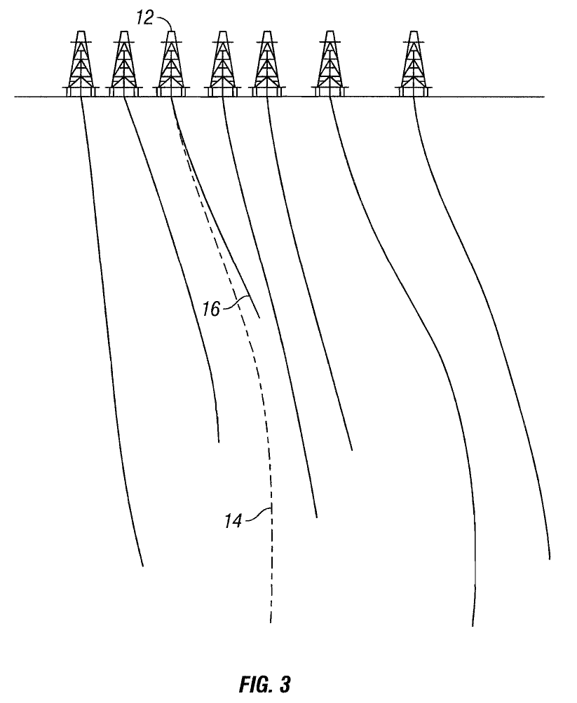

FIG. 1 shows a two-dimensional view of a sample projected well path trajectory 10 measured with respect to true vertical depth from a particular angle. FIG. 2 is a two-dimensional view of well path trajectory in feet with respect to North-South and East-West axes. A projected well path is normally provided to the directional driller. In the present invention, the projected well path is provided as an input to the present software expert system. The type of magnetic orientation survey tool may also be specified by the user, which will affect the operation of the system.

FIG. 3 shows a plurality of wells or projected paths from drill platform 12 and/or other drill platforms (not shown). In this example, the dashed line may represent another projected well path 14. The solid line may represent an actual measured well path 16, which deviates from projected well path 14. The expert directional driller system in accord with the present invention provides real time corrections that are applied to rig components to place well path 16 back on a reasonable course to the target formation within the restraints required. Typical restraints for the corrections may be set and may include a dogleg severity limitation, an angle of proceeding through the target formation, a preferred entry and exit from the target formation, and the like.

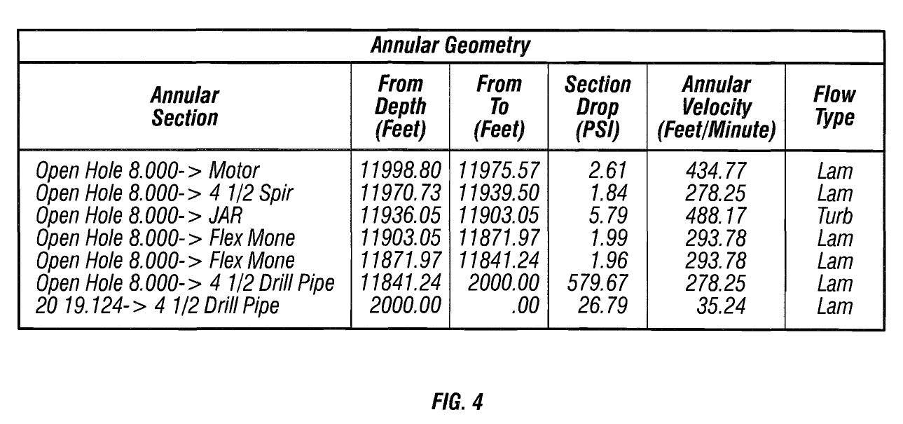

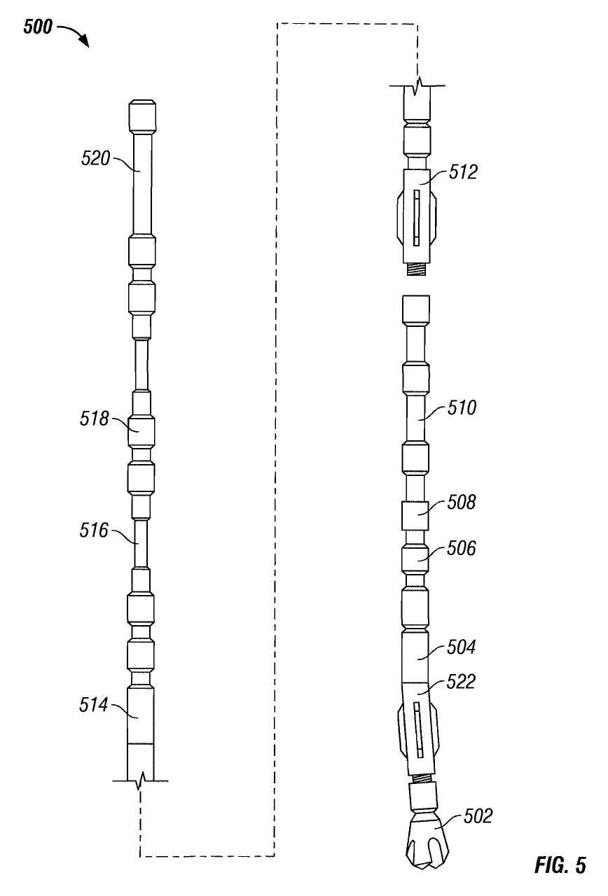

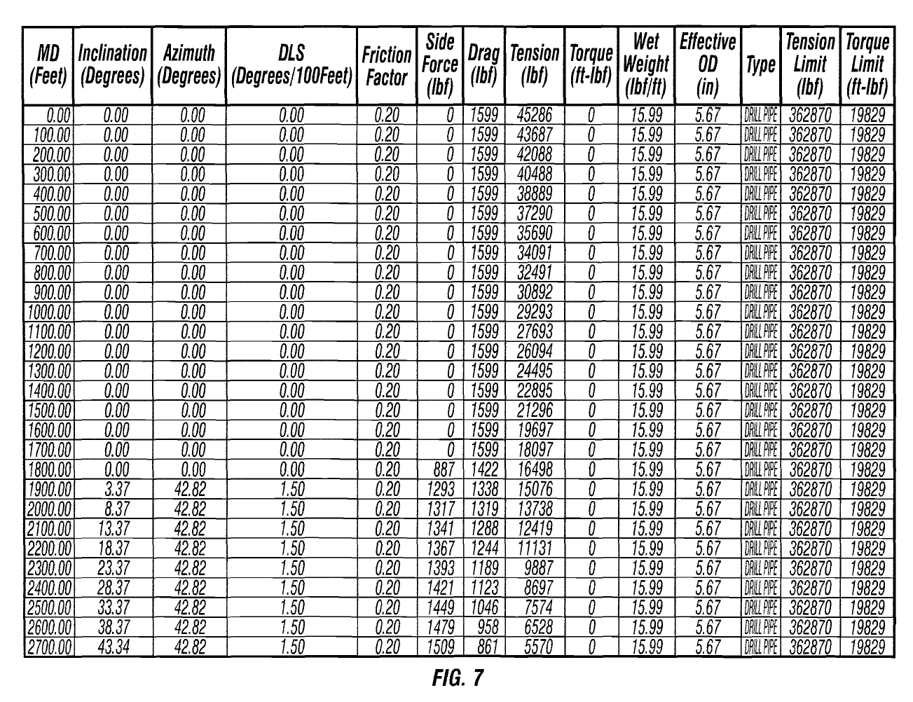

FIG. 4 and FIG. 7 show representative data that may be measured and/or calculated and/or projected as a well is being drilled. This data, or certain elements of the data, is representative of data that is utilized as inputs or projected outputs of the software system of the present invention, as discussed in greater detail hereinafter. As discussed hereinafter in more detail, the software controls surface devices to provide corrective actions that may include changes in torque, RPM, weight on bit (WOB), tool face orientation, mudflow rates, and the like. Other factors related to directional drilling may also be changed but may take considerably more time. More time consuming corrective actions may also be utilized and may include changes in bottom hole assembly (BHA) 500, an example of which is shown in FIG. 5. Other changes may include changing mud weight or composition, and the like. To the extent downhole adjustments may be available, downhole adjustments may also be changed from the surface, such as by acoustic signals through the mud path or the like, and may include changes to adjustable bent sub angles, extendable pads, adjustable centralizers, BHA stiffness, and the like.

FIG. 5 provides one possible representative example of a bottom hole assembly (BHA) 500 that may be utilized for directional drilling. In this example, bit 502 is a DPI Bi-Center drill bit with an O.D. of 8 inches. Information concerning a drill bit, such as a bi-center bit, is provided in a database of bottom hole assemblies within a software expert system. Each bottom hole assembly is arranged to drill a selected portion of the borehole. In known locations, an optimal BHA may already be known.

Each feature of BHA 500 may have a desired effect. For example, the use of a bi-center drill bit results in drilling of a slightly oversize borehole, which may affect the O.D. of other components such as stabilizer 512. In a tight formation, depending on the field, this may allow better functioning of such components as stabilizer 512 by avoiding significant binding against the formation. Other information related to bit 502 provides a desirable range of operation of the drill bit in terms of weight on the bit (WOB), mudflow rates, RPM, and the like. Expected rates of penetration (ROP) can be compared to actual data to determine the need for changing out the bit after various other changes to WOB, mudflow rates, RPM, and the like to achieve the desired ROP have already been effected by the software in accord with the present invention.

Other components of BHA 500 comprise downhole motor 504. In this example, motor 504 also effectively comprises bent sub 522. However, the bent sub is often a separate component, which may be positioned above downhole motor 504. The bent sub provides an angle away from the axis of BHA 500, i.e., the tool face, so that, at least in theory, the hole may be drilled in the direction of the tool face. In this example, orienting sub 506 may be utilized to orient wireline magnetic survey tools with a slot therein that is oriented in the same direction as the bent sub. In this way, the tool face may be oriented utilizing the magnetic survey tool.

Other elements such as crossover 508, spiral drill pipe 510, jar 514 are used here that result in an offset distance between bit 502 and where magnetic survey measurements may be made within non-magnetic drill pipe, i.e., flex monel pipes 516 and 518. An MWD tool, wireline survey tool, single shot magnetic survey too or the like may be sized to place the magnetic sensors within monel pipes 516 and 518 with an orientation shoe that mates to orienting sub 506.

Expert directional driller software in accord with the present invention will determine the distance between the location of the magnetic sensor and the drill bit and project what is the actual position of the bit. Corrections can be made as the sensors get closer to the previous position of the bit. Other pipes such as heavy weight pipes and/or other tubulars such as drill pipe 520 may comprise a portion of BHA 500.

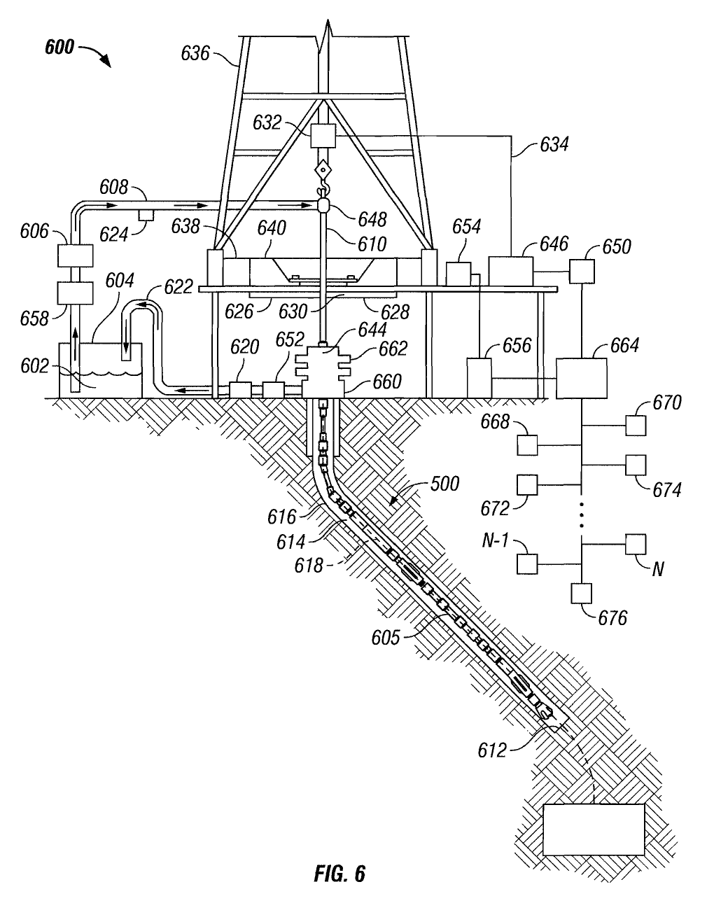

FIG. 6 shows a schematic diagram of a typical drilling rig 600 having a drill string 605 shown conveyed in a borehole 616 for drilling the projected well path. The drilling system 600 may include a conventional derrick 636 having rig floor 638 which supports rotary table 640 that is rotated by a prime mover such as an rotary electric motor 654, diesel pumps with hydraulic operation, or any other prime mover. In this example, electric motor 654 may be controlled by rotary motor controller 656 at a desired rotational speed (RPM). Motor controller 656 may be a silicon controlled rectifier (SCR) system or other suitable system. Motor controller 656 interfaces to rig interface and/or processor 664 whereby directional drilling expert software in accord with the present invention is able to control/monitor RPM.

Rotation may also be achieved by use of a top drive system using similar motor controllers. The drill string 605 comprises a plurality of tubulars that extend downwardly through rotary table 640 and rams 644 and/or other pressure control equipment into the borehole 616. Rams 644 may commonly be hydraulically powered and may contain pressure control sensors 660 for detecting position of the rams, loss of circulation, and/or other operating parameters. Rams 644 may often comprise BOP actuators 662 for controlling the closure members of rams 644 or other pressure control equipment.

As discussed previously with respect to FIG. 5, bottom hole assembly (BHA) 500 comprises drill bit 502, attached to the bottom of BHA 500, that cuts the geological formations when it is rotated to drill borehole 616. In this example, drill string 605 is operatively coupled to blocks 632 via a kelly 610, and swivel 648. Swivel 648 may also connect to mud pump 606 through hose 608. Blocks 632 are lifted and lowered through crown pulley by draw works 646.

In accord with the present invention, during the drilling operation, draw works 646 are controlled by directional drilling expert software in accord with the present invention to thereby control the weight on bit (WOB), which is an important parameter that affects the drilling rate, sometimes referred to as the rate of penetration (ROP). Draw works 646 may comprise an electric motor or other motor. In this example, electronic controller 650 interfaces to rig interface and/or processor 664 whereby operation may be effected by directional drilling expert software in accord with the present invention.

The above description is drawn to a land rig with a rotary table, but the invention as disclosed herein is also equally applicable to any offshore drilling systems and/or top drive systems. Finally, alternatives to conventional drilling rigs, such as coiled tubing systems, can be used to drill boreholes, and the invention disclosed herein is equally applicable to such systems.

During drilling operations, drilling fluid 602 from mud tank(s) 604 is circulated under pressure through drill string 605 by one or more mud pumps 606. Drilling fluid may flow from mud pump 606 into drill string 605, fluid line 608 and kelly joint 610. Drilling fluid 602 may then flow through drill string tubular passageway 618 and may be discharged at the current borehole bottom 612 through one or more openings in drill bit 502. The drilling fluid 602 then circulates up hole through the annulus 614 between the drill string 605 and the borehole 616 and returns to the mud tank 604 through shale shakers, screens, and other solids control devices 620 and then through a mud return line 622. The solids control system 620 and 658 may comprise shale shakers, centrifuges, and automated chemical additive systems, that may contain solids control devices/sensors for controlling various operating parameters, for example centrifuge rpm. Other fluids monitoring sensors 624 may be utilized for monitoring mud condition. Mud pulse sensor 652 may be utilized to communicated with downhole equipment.

Various sensors are installed for monitoring the rig systems. For example, mud flow sensor 624, which might be placed in the mud flow line 608 and/or elsewhere, provides information about the fluid flow rate. Torque sensor 626 and RPM sensor 628 associated with the rotary table/drive 630 provide information about the torque and, when rotating, the rotational speed of drill string 605. Additionally, tension sensor(s) 632 (which may be mounted in various places such as the crown, hook, or the like) associated with and/or connected via cable to draw works 646 and/or other components may be used to provide the hook load of the drill string 605 to rig interface and/or 664. Any of the above sensors and/or other sensors may preferably be connected to rig interface and/or processor 664.

Rig control system processor and/or interface 664 and/or other electronic controllers, e.g., draw works electronic controller 650, rotary motor controller 656, provide software interfaces for monitoring the various sensors and controlling the various motors discussed above such as, but not limited to, sensors for detecting such parameters as motor rpm such as RPM sensor 268. Other sensors may be interfaced to software such as winding voltage, winding resistance, motor current, and motor temperature whereby software provides suitable programming to warn, slow operations, and/or a programmed shut down as necessary. Solids control sensors may be used to indicate operation and control of the various solids control equipment. Interfaces to the mud engineer to provide data therefrom are also available. Still other sensors (not shown) are associated with the pressure control equipment to indicate hydraulic system status and operating pressures of the blow out preventer and choke associated with pressure control device 644.

In one configuration, rig sensor signals are input to rig control system processor and/or interface 664. Rig control processor and/or interface 664 may be located at any suitable location on the rig site. Rig control processor and/or interface 664 may comprise elements such as, for example, a computer, mini-computer, or microprocessor for performing programmed instructions. Rig control processor and/or interface 664 may comprise memory, permanent storage device, and input/output devices. Any memory, permanent storage device, and input/output devices known in the art may be used in rig control processor and/or interface 664. As discussed above, rig control processor and/or interface 664 may also be operably interconnected with the draw works 646 and other mechanical or hydraulic portions of the drilling system 600 for control of the particular parameters of the drilling process.

In one exemplary embodiment, rig control processor and/or interface 664 might comprise what is may be called an autodriller assembly, of a type known in the art for into which a setting for a desired WOB, and other parameters, may be input. Rig control processor and/or interface 664 in the present invention may provide a suitable interface to software in accord with the present invention, which may then operate through rig control processor and/or interface 664 to provide directional drilling services. However, any other electronic interfaces for software control of rig equipment may also be utilized. In the past, rig control processor and/or interface 664 has been used as a type of autopilot, which can maintain the settings within the specified range and/or as a display for sensor information from the rig sensors and other input data from service contractors. In the present invention, rig control processor and/or interface 664 may be operated by directional driller expert software in place of being operated by the directional driller. Directional driller expert software in accord with the present invention may then be utilized to utilize sensor data discussed above, as well as other date such as magnetic survey data, and the projected well path to implement a drilling plan, adjust the tool face, RPM, mud flow rates, torque, to perform the task of directionally drilling the well along the projected well path.

While human oversight of computer controlled equipment is normally always advisable as a backup to a software controlled process, the present software system would allow a relatively few or perhaps only one directional driller to oversee directional drilling operations of many different wells, perhaps hundreds, simultaneously.

Information and status may be communicated using hardwired or wireless techniques to transfer information between a plurality of rig locations, e.g., schematically indicated rig locations 668, 670, 672, 674, . . . N-1, N. In this example, multiple simultaneous directional drilling operations at rig locations 668, 670, 672, . . . N-1, N, may be overseen by one or more directional drillers at directional driller location 676. It will be appreciated that the communication network may be configured differently. It will also be appreciated that human and/or software oversight of the directional drill at location 676, and the rigs, is also available to company personnel at various other locations.

To effect some portions of the projected well path, drill bit 502 is rotated by the drill pipe 520 and through downhole motor 504. This may be referred to as a rotating mode of operation. However, to effect other portions of the projected well path, only downhole motor 504 (mud motor) rotates the drill bit 502. This may be referred to as a sliding mode of operation. During the sliding mode of operation, the bent sub is oriented toward a desired tool face to effect direction drilling although it will be appreciated that many factors affect the direction of drilling. As a general rule, when it is desired to drill in a straight direction, then the drill pipe 520 may also be rotated with downhole motor 504. In a preferred embodiment of the present invention, the expert directional driller software of the present invention determines which course of action to take and then implements this course of action by controlling the appropriate rig equipment to set WOB, RPM when rotating, tension, alignment of the pipe at the surface to control tool face orientation, and control of mud pumps to effect mud flow rate.

As mentioned above, mud motor 504 rotates the drill bit 502 when the drilling fluid 602 passes through the mud motor 504 under pressure. Thus, in the sliding mode of operation, the fluid flow rate of the mud largely determines the RPM of drill bit 502. In either the sliding mode of operation or the rotating mode of operation, the rate of penetration (ROP) of the drill bit 502 into the borehole 26 for a given formation and a drilling assembly often depends largely upon the weight on bit and the drill bit rotational speed.

BHA 500 may contain an MWD and/or LWD assembly that may contain sensors for determining drilling dynamics, directional, and/or formation parameters. Alternatively, MWD or single shot equipment may be lowered by wireline. The sensed values may be transmitted to the surface via a mud pulse transmission, EM signal, wireline signal, or the like. When using mud pulse telemetry for instance, mud pulse receiver or transceiver 652 mounted in mud return line 622 or positioned as necessary for good reception. The telemetry scheme known may normally be operatively connected with rig control processor and/or 664 and/or other suitable interfaces so that the directional driller expert software in accord with the present invention can monitor this important information.

Commonly, the MWD or LWD tools and sensors are owned and operated by a service contractor. Similarly, other service contractors may be providing information concerning the drilling fluids and solids control. Accordingly, directional driller expert software in accord with the present invention has access to this data. For example, directional driller expert software preferably directly control pump strokes related to the pumping flow rate, surface drill pipe tension either for sliding or rotating, drill string surface angular position for sliding operation, and the like.

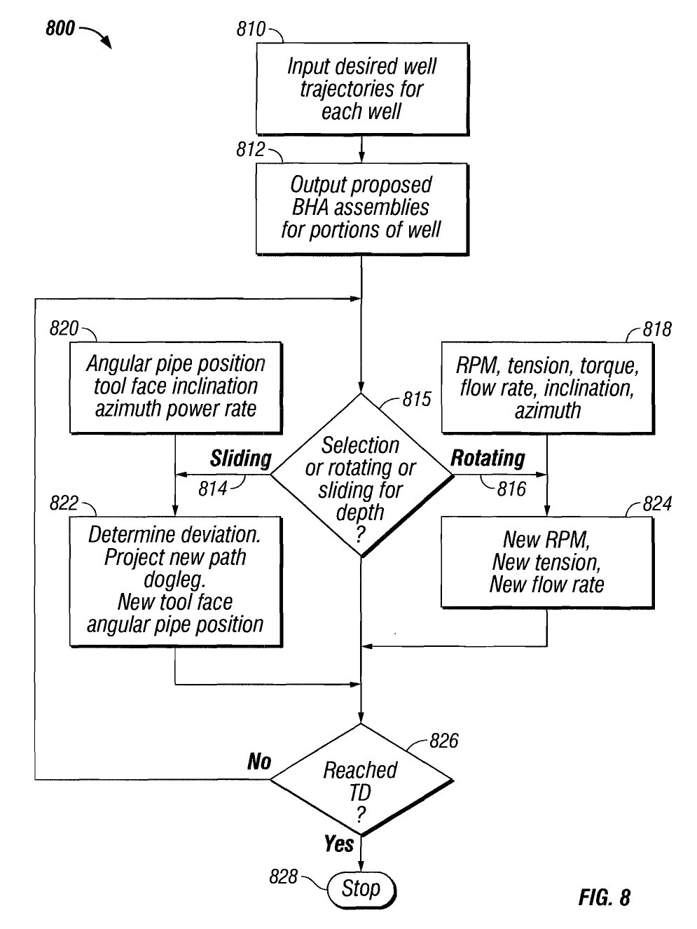

Referring to FIG. 8, directional drilling expert system method 800 may comprise step 810 of inputting a desired trajectories of the proposed well bores such as that shown in FIGS. 1 and 2. Generally, drilling different portions of the well bore will require different BHA assemblies to most efficiently effect the desired trajectories. Accordingly, the software may be utilized determine a plurality of bottom hole assemblies (BHA) as suggested by 812 which may be used to drill the different portions of the desired trajectory. This may be accomplished by providing specifications for a plurality of BHAs and their related components. As well, for particular fields, records of the most successful BHAs can be retained. Any other special drill string components may also be specified and/or obtained.

Other requirements of the well such as any equipment limitations remoteness of the well site with respect to determining the need for advance time to transport equipment, and the like. Thus, the required components for the BHA can be ordered in accord with a time line suitable for the most efficient operation. Therefore, the present invention may also produce or follow or send reminders for a time line for the various activities, logistics, and the like to be preformed.

Prior to operation in a particular segment of the well bore, the actual bottom hole assembly components are preferably manually input or checked off to verify that the directional drilling expert software is basing decisions on the actual BHA which is utilized and is able to make calculations/outputs based thereon. Thus, one calculation, the distance between the bit and the nonmagnetic measurement portion of the bottom hole assembly is determined based on the actual BHA components.

Variables such as measured depth of the wellbore are input. Outputs of the directional drilling expert software may comprise a selection of a rotating mode of drilling or a sliding mode of drilling based on the desired trajectory of the well bore and the measured depth as indicated at 815.

During the rotating mode of drilling as indicated at branch 816, variables such as indicated at 818 may be input. For instance, a measured RPM may typically comprise at least one input to the software whereupon the software verifies the measured RPM is the desired RPM and, if not, the software outputs an adjusted RPM as indicated at 824. Another preferred input may be a measured drill string tension at a surface position whereupon the software verifies the measured drill string tension is a desired surface drill string tension and, if not, then output an adjusted rotating mode drill string tension to effect the desired weight on the bit (WOB).

During the sliding mode of drilling as indicated at branch 814 when exclusively utilizing the downhole drilling motor, variables such as those indicated at 820 may be inputted to the software on a continuing basis comprising a measured angular position of the drill string at a surface position, sliding surface drill string tension, mud flow rate, and/or azimuth and inclination taken at the nonmagnetic measurement portion.

Directional driller expert software evaluates the inputs and, if necessary, then provides outputs such as those indicated at 822. For instance, outputs may comprise an adjusted angular position, an adjusted sliding mode drill string tension, and an adjusted mud flow rate to maintain a projected tool face of the bit wherein the projected tool face is determined utilizing the distance between the bit and the nonmagnetic measurement portion of the bottom hole assembly.

As indicated at 822, the software method may further comprise determining a deviation between the desired trajectory of the well bore and an actual trajectory of the well bore as measured at the nonmagnetic measurement portion of the bottom hole assembly, determining a dogleg of the actual trajectory, and determining a correction trajectory to reduce the deviation between the desired trajectory and the actual trajectory which produces a dogleg less than a predetermined value. During the sliding mode, the method may comprise outputting a command to change at least one of the adjusted angular position, the adjusted sliding mode drill string tension, and an adjusted mud flow rate to provide a corrected projected tool face of the bit wherein the projected tool face is determined utilizing the distance between the bit and the nonmagnetic measurement portion of the bottom hole assembly. The distance between the bit and the nonmagnetic measurement portion of the bottom hole assembly may vary and the software may often have to make this calculation when the distance is greater than 60 feet.

The directional driller expert software continues to evaluate between the processes of rotary drilling mode or sliding mode until the TD depth is reached as indicated at 826 and 828.

For the sliding mode of drilling the software may, if desired, evaluate a rate of drilling and outputting a command to change at least one of the adjusted angular position, an adjusted sliding mode drill string tension, and an adjusted mud flow rate when the rate of drilling drops below a selected rate of drilling. When utilizing a wire line retrievable magnetic compass for inputting the azimuth and the inclination, the software may predict the effect of this change noted directly above on the projected tool face and then compensate by outputting a command to change another of the variables such as the angular position, the adjusted sliding mode drill string tension, and the adjusted mud flow rate to maintain the projected tool face of the bit.

The actual direction of drilling, which may be different from the actual tool, is determined, as noted above, by utilizing the distance between the bit and the nonmagnetic measurement portion of the bottom hole assembly, and the previous trajectory information to make a prediction of what is happening at the bit. What actually occurs is not known until the nonmagnetic measurement portion reaches this point in the hole. If the direction of movement of the bit is different that predicted, then a proposed correction to the path must be made that gets drilling back to the desired well path within constraints such as the dogleg limitations Changes to the variables are made to effect this correction and a new prediction is made as to what is happening at the bit. The method for determining corrections is therefore iterative and involves predicting, measuring, and then changing variables as need.

When utilizing an MWD tool for inputting the azimuth and the inclination the method may comprise compensating for the step of changing by outputting a command to change another of the angular position, the adjusted sliding mode drill string tension, and the adjusted mud flow rate to maintain a selected tool face that is predicted to most closely produce the desired trajectory.

The software method may further comprise measuring a rate of drilling and selectively outputting a command to pick up the drilling string in the rotating mode or to pick up the drill string in the sliding mode when the rate of drilling drops below a selected rate of drilling for the sliding mode or for the rotating mode, then subsequently slacking off to the adjusted rotating mode drill string tension or the adjusted sliding mode drill string tension. For the rotating mode, the method may comprise measuring the rate of drilling and outputting a command to change at least one of the adjusted RPM or the adjusted rotating mode drill string tension when the rate of drilling drops below a selected rate of drilling.

To more accurately determine WOB, the software method may further comprise inputting a friction factor for the drill string, inputting an effective OD of drill string components, determining a friction of the drill string, and utilizing the friction of the drill string for calculating a weight on bit whereby the adjusted sliding mode drill string tension is selected.

The software method may further comprise inputting a mud weight and determining a buoyancy of the drill string, and utilizing the buoyancy of the drill string for calculating a weight on bit whereby the adjusted sliding mode drill string tension is selected.

If desired, the directional driller expert software in accord with the present invention may also be adapted to include functions that are not normally considered part of the directional drilling aspect but which may be controlled during typical drilling situations whether or not directional drilling techniques are being utilized.

The present invention may be implemented as a set of instructions on a computer readable medium, comprising ROM, RAM, CD ROM, Flash or any other readable medium, now known or unknown that when executed cause a computer to implement the method of the present invention. The system may implemented in more standard programming, or may use fuzzy logic, or a neural network.

Electronic data recorders are computers that are connected to various measurement devices on the drilling rig and digitally record the data onto a hard however, they nearly all require communication with the surface in order to configure themselves. This is normally done with the mud pumps, or with a pulser that pulses a series of commands. Another class of directional control tools known as adjustable stabilizers also uses mud pulse protocols to adjust themselves. All of these protocols can be programmed into the logic of the directional drilling software, allowing for automation of said tools. Such a system will not necessarily replace a directional driller, any more than computers have replaced pilots. However, at a minimum, it does redefine the way a directional driller works. His primary responsibility may become monitoring, and overriding what the computer controlled system is doing, if necessary, perhaps overseeing drilling for a plurality of wells at once.

Accordingly, the foregoing disclosure and description of the invention is illustrative and explanatory thereof, and it will be appreciated by those skilled in the art, that various changes in the ordering of steps, ranges, and/or attributes and parameters, as well as in the details of the illustrations or combinations of features of the software methods and apparatus discussed herein, may be made without departing from the spirit of the invention.

What is claimed is:

1. A software method for directional drilling of a plurality of well bores with a respectively located drill string comprising a bottom hole assembly, said bottom hole assembly comprising a downhole drilling motor, a bent sub, a nonmagnetic measurement portion, and a bit, said bottom hole assembly being supported by a surface positioned drilling system, said software method comprising:
providing steps of inputting to and outputting from with respect to a processor controlled by software in a memory that is remotely located from said plurality of well bores, comprising
inputting a desired trajectory of said plurality of well bores,
inputting a distance between said bit and said nonmagnetic measurement portion of said bottom hole assembly,
inputting a measured depth of said plurality of well bores,
outputting a selection of a rotating mode of drilling or a sliding mode of drilling based on said desired trajectory of said plurality of well bores and said depth, further comprising,
during said rotating mode of drilling sensing RPM and outputting an adjusted RPM, measuring drill string tension at a surface position and outputting an adjusted rotating mode drill string tension, and
during said sliding mode of drilling when exclusively utilizing said downhole drilling motor for rotating said bit then sensing an angular position of said drill string at a surface position, sensing said drill string tension at said surface position, sensing mud flow rate, sensing an azimuth and an inclination taken at said nonmagnetic measurement portion, and outputting an adjusted angular position, an adjusted sliding mode drill string tension, and an adjusted mud flow rate to maintain a tool face, determining a projected direction of drilling of said well bore.

2. The software method of claim 1 further comprising determining a deviation between said desired trajectory of said plurality of well bores and an actual trajectory of said plurality of well bores as measured at said nonmagnetic measurement portion of said bottom hole assembly, determining a dogleg of said actual trajectory, and determining a correction trajectory to reduce said deviation between said desired trajectory and said actual trajectory which produces a dogleg less than a predetermined value, and projecting a new projected direction of drilling of said well bore wherein said new projected of drilling is determined utilizing said distance between said bit and said nonmagnetic measurement portion of said bottom hole assembly and said correction trajectory.

3. The method of claim 1 wherein said software method utilizes a wire line retrievable magnetic compass for sensing of said azimuth and said inclination of said well bore.

4. The method of claim 1 wherein said software generates an initial configuration for said bottom hole assembly whereby an actual configuration or confirmation is inputted.

5. The software method of claim 1 further comprising for said sliding mode sensing a rate of drilling and outputting a command to said surface positioned drilling system for changing at least one of said adjusted angular position, an adjusted sliding mode drill string tension, and an adjusted mud flow rate when said rate of drilling drops below a selected rate of drilling.

6. The software method of claim 5 further comprising predicting an effect of said step of outputting said command for changing on said projected tool face and then compensating for said command for changing by outputting a command to change another of said angular position, said adjusted sliding mode drill string tension, and said adjusted mud flow rate to maintain said projected tool face of said bit wherein said projected tool face is determined utilizing said distance between said bit and said nonmagnetic measurement portion of said bottom hole assembly.

7. The software method of claim 1 further comprising:
measuring a rate of drilling and selectively outputting a command to said surface drilling system to pick up said drilling string in said rotating mode or to pick up said drill string in said sliding mode when said rate of drilling drops below a selected rate of drilling for said sliding mode or for said rotating mode, then subsequently slacking off to said adjusted rotating mode drill string tension or said adjusted sliding mode drill string tension.

8. The software method of claim 7 further comprising measuring said rate of drilling and outputting a command to said surface drilling system to change at least one of said adjusted RPM or said adjusted rotating mode drill string tension when said rate of drilling drops below a selected rate of drilling for said rotating mode.

9. The software method of claim 8 further comprising during said sliding mode then outputting a command to said surface drilling system to change at least one of said adjusted angular position, said adjusted sliding mode drill string tension, and an adjusted mud flow rate to provide a corrected projected tool face of said bit wherein said projected tool face is determined utilizing said distance between said bit and said nonmagnetic measurement portion of said bottom hole assembly.

10. The software method of claim 1 wherein said distance between said bit and said nonmagnetic measurement portion of said bottom hole assembly is greater than 60 feet.

11. The software method of claim 1 further comprising inputting a friction factor for said drill string, inputting an effective OD of drill string components, and determining a friction of said drill string.

12. The software method of claim 7 further comprising inputting a mud weight and determining a buoyancy of said drill string.

13. A software method for directional drilling of a well bore with a drill string and a surface drilling system to support said drill string, comprising:
inputting a desired trajectory of said well bore;
inputting a distance between a bit and a nonmagnetic measurement portion of a bottom hole assembly wherein during at least one portion of said directional drilling said bottom hole assembly comprising at least a downhole drilling motor, a bent sub, said bit, and said nonmagnetic measurement portion;
inputting a measured depth of said well bore;
outputting a selection of a rotating mode of drilling or a sliding mode of drilling based on said desired trajectory of said well bore and said depth, further comprising,
during said rotating mode of drilling then inputting a measured RPM and outputting to said surface drilling system an adjusted RPM, inputting a measured drill string tension at a surface position and outputting to said surface drilling system an adjusted rotating mode drill string tension;
during said sliding mode of drilling when exclusively utilizing said downhole drilling motor then inputting an angular position of said drill string at a surface position, inputting said drill string tension at said surface position, inputting mud flow rate, inputting an azimuth and an inclination taken at said nonmagnetic measurement portion, and outputting to said surface drilling system an adjusted angular position, an adjusted sliding mode drill string tension, and an adjusted mud flow rate to maintain a tool face of said bit, determining a projected direction of drilling of said well bore wherein said projected direction of drilling is determined utilizing said distance between said bit and said nonmagnetic measurement portion of said bottom hole assembly.

14. The software method of claim 13 further comprising determining a deviation between said desired trajectory of said well bore and an actual trajectory of said well bore as measured at said nonmagnetic measurement portion of said bottom hole assembly, determining a dogleg of said actual trajectory, and determining a correction trajectory to reduce said deviation between said desired trajectory and said actual trajectory which produces a dogleg less than a predetermined value, and determining a new projected direction of drilling of said well bore wherein said new projected direction of drilling is determined utilizing said distance between said bit and said nonmagnetic measurement portion of said bottom hole assembly and said correction trajectory.

15. The software method of claim 13 further comprising for said sliding mode measuring a rate of drilling and outputting a command for changing at least one of said adjusted angular position, an adjusted sliding mode drill string tension, and an adjusted mud flow rate when said rate of drilling drops below a selected rate of drilling.

16. The software method of claim 15 further comprising when utilizing a wire line retrievable magnetic compass for inputting said azimuth and said inclination then predicting an effect of outputting said command for changing on said projected tool face and then compensating for outputting said command for changing by outputting a command to change another of said angular position, said adjusted sliding mode drill string tension, and said adjusted mud flow rate to maintain said projected tool face of said bit wherein said projected tool face is determined utilizing said distance between said bit and said nonmagnetic measurement portion of said bottom hole assembly.

17. The software method of claim 15 when utilizing an MWD tool for inputting said azimuth and said inclination then compensating for said command for changing by outputting a command to change another of said angular position, said adjusted sliding mode drill string tension, and said adjusted mud flow rate to maintain a selected tool face that is predicted to most closely produce said desired trajectory.

18. The software method of claim 13 further comprising:
measuring a rate of drilling and selectively outputting a command to said surface drilling system to pick up said drilling string in said rotating mode or to pick up said drill string in said sliding mode when said rate of drilling drops below a selected rate of drilling for said sliding mode or for said rotating mode, then subsequently slacking off to said adjusted rotating mode drill string tension or said adjusted sliding mode drill string tension.

19. The software method of claim 17 further comprising for said rotating mode measuring said rate of drilling and outputting a command to change at least one of said adjusted RPM or said adjusted rotating mode drill string tension when said rate of drilling drops below a selected rate of drilling.

20. The software method of claim 19 further comprising during said sliding mode then outputting a command to said surface drilling system to change at least one of said adjusted angular position, said adjusted sliding mode drill string tension, and an adjusted mud flow rate to provide a corrected tool face of said bit wherein said corrected tool face is projected to utilizing said distance between said bit and said nonmagnetic measurement portion of said bottom hole assembly.

21. The software method of claim 13 wherein said distance between said bit and said nonmagnetic measurement portion of said bottom hole assembly is greater than 60 feet.

22. The software method of claim 13 further comprising inputting a friction factor for said drill string, inputting an effective OD of drill string components, and determining a friction of said drill string, and utilizing said friction of said drill string for calculating a weight on bit whereby said adjusted sliding mode drill string tension is selected.

23. The software method of claim 22 further comprising inputting a mud weight and determining a buoyancy of said drill string, and utilizing said buoyancy of said drill string for calculating a weight on bit whereby said adjusted sliding mode drill string tension is selected.

24. The software of claim 13 further comprising outputting a configuration of said bottom hole assembly based on said desired trajectory and inputting one or more verified bottom hole assemblies.
